(19) United States
(12) Patent Application Publication
(10) Pub. No.: US 2017/0092052 A1
(43) Pub. Date: Mar. 30, 2017

(54) SYSTEMS AND METHODS OF ELECTRONIC GAMING

(71) Applicant: Aristocrat Technologies Australia Pty Limited, North Ryde (AU)

(72) Inventors: Linn Anthony McKAY, Henderson, NV (US); Rajendrasinh Banesinh JADEJA, Las Vegas, NV (US); Dominic Steve BIONDO, Las Vegas, NV (US); Timothy Francis BARBOUR, Las Vegas, NV (US)

(21) Appl. No.: 15/274,203

(22) Filed: Sep. 23, 2016

Related U.S. Application Data
(60) Provisional application No. 62/232,883, filed on Sep. 25, 2015.

(51) Int. Cl. G07F 17/32

(52) U.S. Cl. CPC G07F 17/3216

(57) ABSTRACT

A gaming cabinet assembly is disclosed. The gaming cabinet assembly may comprise a support cabinet, which may in turn comprise a first hinge member. The gaming cabinet assembly may further comprise a secondary cabinet, which may in turn comprise a second hinge member. The second hinge member may be hingedly coupled to the first hinge member, such that the secondary cabinet moves, relative to the support cabinet, between a first position and a second position.

### CROSS-REFERENCE TO RELATED APPLICATIONS

This application claims the benefit of priority to U.S. Provisional Patent Application No. 62/232,883 filed Sep. 25, 2015, entitled A GAMING CABINET, the entire contents and disclosure of which are hereby incorporated by reference in their entirety.

### BACKGROUND

Gaming machines, such as slot machines, often include a main display for presenting a primary game play and outcome information and a secondary display for displaying secondary game information, such as bonus game or feature game information. The main display may be housed within a main cabinet (or “support cabinet”), and the secondary display may be housed within a secondary cabinet, (or “top box”) which may be mounted atop the main cabinet.

Accordingly, during installation and maintenance activities, the secondary cabinet may be hoisted above the support cabinet as well as taken down from atop secondary cabinet. These operations can be difficult and may result in physical strain or even injury to a technician lifting the secondary cabinet.

### SUMMARY

In a first aspect, a gaming cabinet assembly is disclosed. The gaming cabinet assembly may comprise a support cabinet, which may in turn comprise a first hinge member. The gaming cabinet assembly may further comprise a secondary cabinet, which may in turn comprise a second hinge member. The second hinge member may be hingedly coupled to the first hinge member, such that the secondary cabinet moves, relative to the support cabinet, between a first position and a second position.

In another aspect, a support cabinet of a gaming cabinet assembly is disclosed. The support cabinet may comprise a hinge member, which may be configured to engage with a hinge member of a secondary cabinet such that the secondary cabinet moves, relative to the support cabinet, between a first position and a second position, the secondary cabinet situated atop and supported by the support cabinet in the second position.

In yet another aspect, a secondary cabinet of a gaming cabinet assembly is disclosed. The secondary cabinet may comprise a hinge member, which may be configured to engage with a hinge member of a support cabinet such that the secondary cabinet moves, relative to the support cabinet, between a first position and a second position, the secondary cabinet situated atop and supported by the support cabinet in the second position.

### BRIEF DESCRIPTION OF THE DRAWINGS

An exemplary embodiment of the subject matter disclosed will now be described with reference to the accompanying drawings.

FIG. 1a is a perspective view of an embodiment of a gaming cabinet assembly in an in-use position.

FIG. 1b is a perspective view of an alternative embodiment of a gaming cabinet assembly in an in-use position.

FIG. 2 is a perspective view of an embodiment of a gaming cabinet assembly in a non-use position.

FIG. 3 is a perspective view of a gaming cabinet assembly in which a secondary cabinet is separated from a support cabinet.

FIG. 4 is a perspective view of a hinge mechanism of a gaming cabinet assembly.

### DETAILED DESCRIPTION

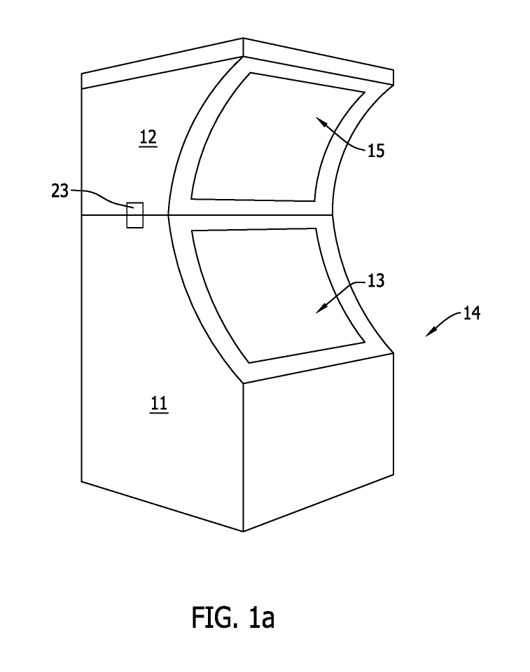

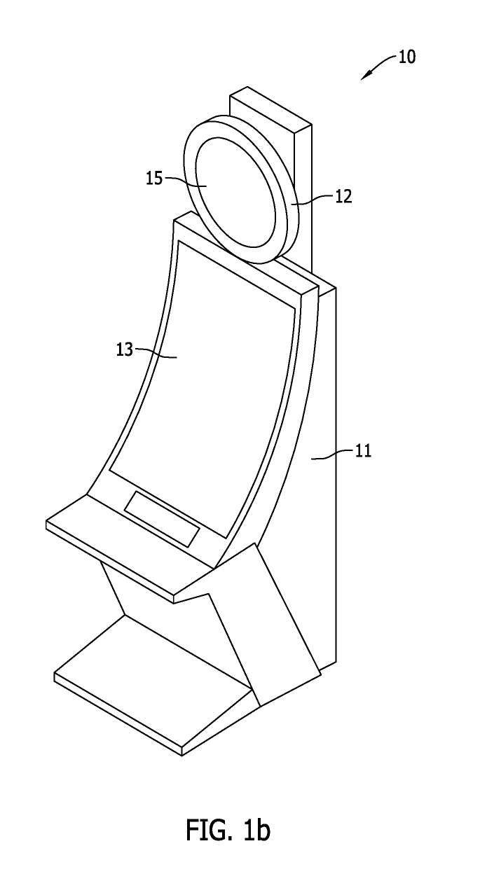

FIG. 1a is a perspective view of an exemplary embodiment of a gaming cabinet assembly 10. Gaming cabinet assembly 10 may include a support cabinet 11 and a secondary cabinet 12. As described herein, during operation, secondary cabinet 12 may be supported by, and rest atop, support cabinet 11.

In the exemplary embodiment, support cabinet 11 may include a first plurality of gaming machine components, such as, for example, a first display 13, a gaming machine controller, an input interface, a credit acceptor (e.g., a bill or coin accept, a credit or debit card acceptor, a ticket acceptor), and the like. Similarly, secondary cabinet 12 may include a second plurality of gaming machine components, such as, for example, a second display 15, a plurality of lights (e.g., a top box candle), and the like. In various embodiments, each of first display 13 and second display 15 comprises an electronic display. Support cabinet 11 may be at least 1.5 meters in height. In an exemplary embodiment, support cabinet 11 is at least 1.8 meters in height. FIG. 1b is a perspective view of an embodiment of a gaming cabinet assembly 10 in which secondary cabinet 12 includes a circular or rounded display, such as a wheel display, or a display configured to display a wheel game. In an exemplary embodiment first display 13 and second display 15 may comprise outward facing surfaces which may together define a curved display surface, such as, for example, a concave display surface.

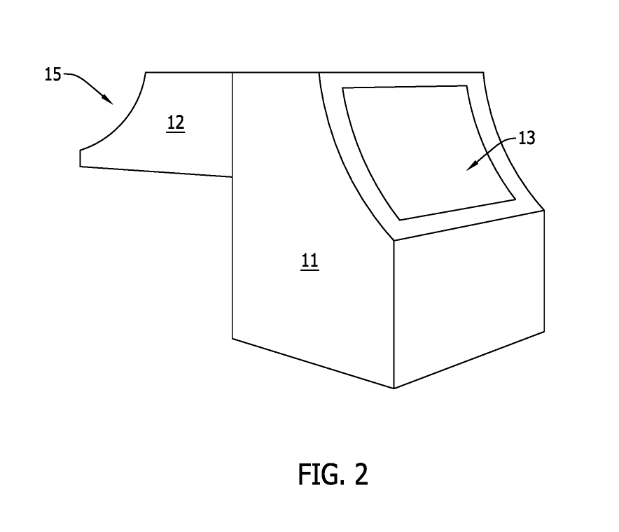

FIG. 2 is a perspective view of an embodiment of gaming cabinet assembly 10 in a non-use position or configuration. In an exemplary embodiment, secondary cabinet 12 may be coupled to support cabinet 11 by a securing mechanism, such as by a hinge assembly (described below). Further, as described in greater detail below, secondary cabinet 12 may be moveable between two configurations or positions through movement or rotation of secondary cabinet 12 relative to support cabinet 11 about the securing mechanism.

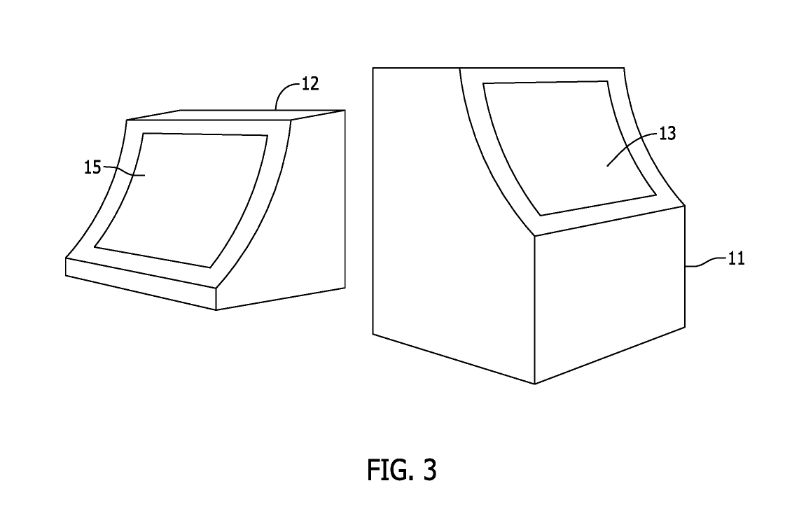

FIG. 3 is a perspective view of gaming cabinet assembly 10 in which secondary cabinet 12 is separated from support cabinet 11. In an exemplary embodiment, the securing mechanism may include a hinge assembly, which may include a first hinge member 21 and a second hinge member 22. The securing mechanism may facilitate detachment of secondary cabinet 12 from support cabinet 11. The securing mechanism may further facilitate detachment of secondary cabinet 12 from support cabinet 11 only when secondary cabinet 12 is in the non-use configuration or position (as shown at FIG. 2). Similarly, securing mechanism may facilitate attachment of secondary cabinet 12 to the support cabinet 11, such as when attachment would result in the non-use configuration.

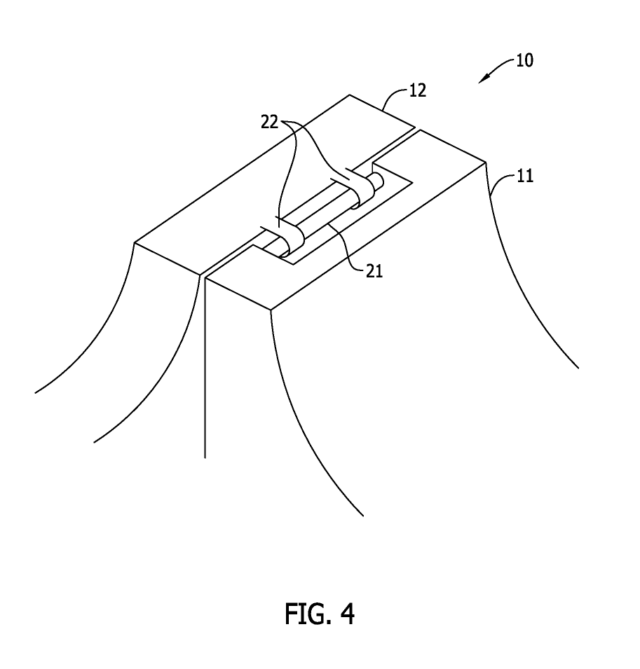

In an exemplary embodiment, and as shown at FIG. 4, first hinge member 21 may be located on support cabinet 11, and second hinge member 22 may be located on head unit 12. First hinge member 21 may comprise an elongated cylindrical member that is configured to engage with second hinge member 22, which may, in turn, comprise one or more hooks or latches configured to hingedly couple to first hinge member 21. First hinge member 21 and second hinge member 22 may therefore facilitate rotation of secondary cabinet 12 about an axis of first hinge member 21. First hinge member 21 may be located, in various embodiments, within a recess of support cabinet 11 and second hinge member 22 may, similarly, be located with a recess of secondary cabinet 12.

Support cabinet 11 and secondary cabinet 12 may further include a locking mechanism (not shown). The locking mechanism may lock secondary cabinet 12 onto support cabinet 11 when secondary cabinet 12 is situated atop support cabinet 11 in an in-use configuration or position. To this end, the locking mechanism may comprise, for example, one or more fasteners located on support cabinet 11 and/or one or more fasteners located on secondary cabinet 12. The fasteners may comprise any suitable fastener or plurality of fasteners, such as any latch, clasp, or similar device. The fasteners may mechanically couple support cabinet 11 to secondary cabinet 12.

Thus, in operation, the securing mechanism facilitates the interface between secondary cabinet 12 from support cabinet 11. In particular, the securing mechanism facilitates attachment of secondary cabinet 12 to support cabinet 11 as well as removal of secondary cabinet 12 from support cabinet 11. In addition, the securing mechanism may facilitate transition of gaming cabinet assembly 10 between in-use and non-use configurations or positions, which may, in turn, facilitate installation of secondary cabinet 12 atop support cabinet 11. More particularly, a technician may couple second hinge member 22 of secondary cabinet 12 to first hinge member 21 of support cabinet 11, such that secondary cabinet 12 may swing from a hanging position to a seated position atop support cabinet 11. It may not, therefore, be necessary to lift the whole weight of the secondary cabinet 12 to a level sufficient to place the secondary cabinet 12 atop support cabinet 11. Rather, secondary cabinet 12 may be lifted to a lower level, sufficient only to engage the second hinge member 22 with the first hinge member 21. Gaming cabinet assembly 10 may therefore reduce physical stress placed on a technician during installation of secondary cabinet 12 atop support cabinet 11. Another advantage can be the reduction in the number of technicians required to set up gaming cabinet assembly 10.

In an exemplary embodiment, support cabinet 11 may be operational and configured for game play irrespective of the disposition of secondary cabinet 12. For example, support cabinet 11 may be used for game play (e.g., user interaction) when secondary cabinet 12 is attached as well as when secondary cabinet 12 is detached. Alternatively, support cabinet 11 may be configured for game play only when secondary cabinet 12 is attached and, optionally, only when secondary cabinet 12 is configured in the in-use position. In an exemplary embodiment, secondary cabinet 12 may augment the game being played on support cabinet 12. In addition, secondary cabinet 12 may provide a game (or other game information) that is separate from the game provided by support cabinet 11. In various embodiments, an example augmented experience is the display of game information via second display 15 in addition to game information presented by first display 13. Secondary cabinet 12 may further provide an interactive experience.

In various embodiments, gaming cabinet assembly 10 may include a damper. For example secondary cabinet 12 may include a damper and/or support cabinet 11 may include a damper. A damper may comprise any element, such as a shock absorbing material (e.g., a foam), that dampens, or is suitable to dampen, motion of secondary cabinet 12 as it moves from a non-use configuration into an in-use configuration. The damper may further slow the rate at which secondary cabinet 12 approaches (or swings downward towards) support cabinet 11 during detachment from support cabinet 11.

In the claims which follow and in the preceding disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

It will be understood to persons skilled in the art of the invention that many modifications may be made without departing from the spirit and scope of the disclosure.

What is claimed is:

1. A gaming cabinet assembly comprising:
a support cabinet comprising a first hinge member; and
a secondary cabinet comprising a second hinge member, the second hinge member hingedly coupled to the first hinge member, such that the secondary cabinet moves, relative to the support cabinet, between a first position and a second position.

2. A gaming cabinet as claimed in claim 1, wherein the second position corresponds to the secondary cabinet being situated atop and supported by the support cabinet.

3. A gaming cabinet as claimed in claim 1, wherein the first position corresponds to the secondary cabinet being in a non-use configuration.

4. A gaming cabinet as claimed in claim 1, wherein the second position corresponds to the s being in an in-use configuration.

5. A gaming cabinet as claimed in claim 1, wherein the first hinge member comprises an elongated cylindrical member and the second hinge member comprises at least one clasp.

6. A gaming cabinet as claimed in claim 1, wherein the second hinge member comprises a hook and the first hinge member comprises a hook engaging feature.

7. A gaming cabinet as claimed in claim 1, wherein the first hinge member comprises an elongated cylindrical member and the second hinge member comprises a clasp.

8. A gaming cabinet as claimed in claim 1, wherein the first hinge member is located within a recess of the support cabinet.

9. A gaming cabinet as claimed in claim 1, wherein the second hinge member is located within a recess of the secondary cabinet.

10. A gaming cabinet as claimed in claim 1, wherein the support cabinet comprises a first display and one or more user input controls.

11. A gaming cabinet as claimed in claim 10, wherein the secondary cabinet comprises a second display.

12. A gaming cabinet as claimed in claim 11, wherein the second display is configured to display game information configured to augment game information presented by the first display.

13. A gaming cabinet as claimed in claim 10, wherein the first display and the second display together define a substantially continuous arc when the secondary cabinet is in the second position.

14. A gaming cabinet as claimed in claim 11, wherein the second display is a wheel display.

15. A gaming cabinet as claimed in claim 1, wherein the secondary cabinet is removable from the support cabinet only when at least substantially in the first position.

16. A gaming cabinet as claimed in claim 1, further comprising a locking mechanism that fixes the secondary cabinet to the support cabinet when the secondary cabinet is in the second position.

17. A gaming cabinet as claimed in claim 1, further comprising a damper that damps a motion of the secondary cabinet when the secondary cabinet is moved from the first position to the second position.

18. A gaming cabinet as claimed in claim 17, wherein the secondary cabinet comprises the damper.

19. A gaming cabinet as claimed in claim 1, wherein the support cabinet has a height of at least 1.5 meters.

20. A gaming cabinet as claimed in claim 1, wherein the support cabinet has a height of at least 1.8 meters.

21. A support cabinet of a gaming cabinet assembly, the support cabinet comprising:
a hinge member, the hinge member configured to engage with a hinge member of a secondary cabinet such that the secondary cabinet moves, relative to the support cabinet, between a first position and a second position, the secondary cabinet situated atop and supported by the support cabinet in the second position.

22. A secondary cabinet of a gaming cabinet assembly, the secondary cabinet comprising:
a hinge member, the hinge member configured to engage with a hinge member of a support cabinet such that the secondary cabinet moves, relative to the support cabinet, between a first position and a second position, the secondary cabinet situated atop and supported by the support cabinet in the second position.
